(19) United States
(12) Patent Application Publication
(10) Pub. No.: US 2011/0259115 A1
(43) Pub. Date: Oct. 27, 2011

(54) STRUCTURAL LOAD MONITORING USING COLLARS AND CONNECTING ELEMENTS WITH STRAIN SENSORS

(75) Inventors: Damon Roberts, Southampton (GB); Rogerio Ramos, Hampshire (GB); Lars Mangal, Hellerup (DK)

(73) Assignee: SCHLUMBERGER TECHNOLOGY CORPORATION, Sugar Land, TX (US)

(21) Appl. No.: 12/865,005

(22) PCT Filed: Jan. 28, 2009
(86) PCT No.: PCT/GB2009/000230

§ 371 Date: Apr. 8, 2011

(30) Foreign Application Priority Data
Jan. 28, 2008 (GB) 0801499.5

(51) Int. Cl. G01L 1/24; F16L 55/00

(52) U.S. Cl. 73/800; 138/104

(57) ABSTRACT

A system and method for measuring loads on a pipe, including a pair of collars that can be secured around the outer surface of the pipe to be monitored in an axially spaced relationship; and a connecting element having a strain gauge is fixed to the collars such that when the collars are secured to the pipe, the connecting element is arranged to measure distortion of the pipe due to applied loads, wherein the ends of the connecting element are attached to the collars such that when the collars are secured to the pipe, the ends of the connecting element are fixed against axial and circumferential movement relative to the pipe. The system includes the apparatus mounted on a pipe, such as a flexible pipe, in a subsea oil or gas installation.

### CROSS REFERENCE TO RELATED DOCUMENTS

We claim benefit of priority to Great Britain Patent Application Serial No. 0801499.5 of ROBERTS et al., entitled “STRUCTURAL LOAD MONITORING USING COLLARS AND CONNECTING ELEMENTS WITH STRAIN SENSORS,” filed on Jan. 28, 2008, the entire content of which is hereby incorporated by reference herein.

### BACKGROUND OF THE INVENTION

1. Field of the Invention

The present invention generally relates to systems and methods for monitoring loads on pipes, and more particularly to a system and method for monitoring loads on pipes used in the subsea oil and gas industry.

2. Discussion of the Background

Flexible pipes are increasingly used in systems for the subsea oil and gas industry. There are considerable advantages in the cost and ease of deployment that can be obtained by using such systems. However, the movement allowed by such flexible systems also can create potential for failure of the flexible pipes, which can be both costly and dangerous. To date, there is little historical experience that the industry can use to evaluate such risks in advance and because of the serious nature of the consequences of failure, it is desirable to monitor such pipes frequently or continuously.

Some systems have been proposed for detecting damage or failure in aspects of a pipe structure that could lead to catastrophic failure of the pipe if left unattended. An example of this can be found in U.S. Pat. No. 7,296,480. In this case, a strain gauge attached to a connecting structure in the form of a rod is mounted on the side of a flexible pipe so as to measure the twist in the pipe near an end-fitting resulting from failure of one or more reinforcing plies in the pipe. A fiber optic sensor is held in place circumferentially on the pipe at various locations but is free to slide axially. In this way, twist can be measured, which is the result of ply failure. This measurement, which may be combined with gas detection, can be used to detect failure. However, such a system is limited in that it only measures twist at an end-fitting resulting from the failure or one or more plies.

### SUMMARY OF THE INVENTION

Therefore, there is a need for a method and apparatus (e.g., which also can be referred to herein as a “system”) that addresses the above and other problems. The above and other needs and problems are addressed by the exemplary embodiments of the present invention, which provide a method and apparatus for measurement and detection of pipe deformation arising from the loads imposed upon the pipe in use. It is also an object to provide a system that can be used to discriminate between the deformations in various sections of the pipe. The invention achieves these objectives by using pairs of collars to locate the ends of connecting elements, which include strain gauges and so as to provide a reference for different types of deformation measurement and load determination, advantageously, without the need to wait for failure to occur.

Accordingly, in a first exemplary aspect of the present invention there is provided an apparatus for measuring loads on a pipe, including a pair of collars that can be secured around the outer surface of the pipe to be monitored in an axially spaced relationship; and a connecting element fixed to the collars such that when the collars are secured to the pipe, distortion of the pipe due to applied loads causes distortion of the connecting element. The ends of the connecting element are attached to the collars, such that when the collars are secured to the pipe, the ends of the connecting element are fixed against axial and circumferential movement relative to the pipe; and a strain gauge is fixed to or included in the connecting element so as to measure distortion of the connecting element. The strain gauge can be a fiber optic device, e.g., a Bragg grating device. However, any suitable strain gauges or extensometers, such as optical strain gauges and extensometers, electrical strain gauges and extensometers, and the like, can be employed.

The connecting element may have different shapes, including a cross section that can be round, oval, square, or rectangular, for example. The cross section of the connecting element can also vary in shape or dimensions with length. The mechanical properties of the connecting element can also vary with length. These variations with length can be used to optimize the performance of the measurements. For example, they can vary in such way that the stiffness of the connecting element is reduced at locations where the sensing elements are placed.

The attachment points on the collars for connecting elements can be aligned axially, or offset circumferentially relative to the surface of the pipe so that the connecting element lies at an angle to the pipe axis. The attachment points can also be offset radially from the surface of the pipe. Multiple connecting elements can be fixed between the collars, in which case the strain gauges can be mounted so as to have different alignment between the collars. In another example, more than two collars are provided, the connecting elements being connected between, i.e., with, two or more of the collars.

In a second exemplary aspect of the invention there is provided an installation for measuring loads on a pipe, including an apparatus according to the first aspect of the invention mounted on a pipe to be monitored. The installation can also include a data acquisition and analysis unit, and means for passing data back to the unit from the strain gauge or gauges. A number of apparatus installations can be provided, spaced apart along the pipe to be monitored. The pipe can be rigid, semi-rigid or flexible. Such pipes can advantageously be used in subsea oil and gas installations.

In a third exemplary aspect of the invention there is provided a method of monitoring loads on a pipe, including providing a pair of collars having one or more connecting elements fixed therebetween; securing the collars in an axially spaced relationship around the outer surface of the pipe to be monitored, such that when the collars are secured to the pipe, the ends of the one or more connecting elements are fixed against axial and circumferential movement relative to the pipe, such that distortion of the pipe due to applied loads causes distortion of the connecting elements; providing a strain gauge fixed to the one or more connecting elements so as to measure distortion of the one or more connecting elements; and measuring distortion of the pipe due to applied loads. The method can be performed using an apparatus according to the first aspect of the invention. It is advantageous to provide multiple apparatus located at different locations on the pipe to be measured.

Still other aspects, features, and advantages of the present invention are readily apparent from the entire description thereof, including the figures, which illustrates a number of exemplary embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates schematically an exemplary subsea system in which the present invention is applicable;

FIG. 2 illustrates an exemplary matrix of collars and connecting elements with strain gauges for monitoring of a pipe structure;

FIG. 3 illustrates an exemplary matrix of collars and connecting elements with strain gauges in a crisscross pattern for monitoring of a pipe structure;

FIG. 4 illustrates an exemplary matrix of collars and connecting elements with strain gauges with radial extensions for monitoring of a pipe structure;

FIG. 5 illustrates an exemplary matrix of collars and connecting elements with strain gauges of varied thickness for monitoring of a pipe structure

FIG. 6 illustrates an exemplary plurality of matrices of collars and connecting elements with strain gauges for monitoring of a pipe structure;

FIG. 7 illustrates another exemplary plurality of matrices of collars and connecting elements with strain gauges with varied orientations and arrangements for monitoring of a pipe structure;

FIG. 8A illustrates exemplary collar and connecting elements with strain gauge installations coupled to a data acquisition and analysis unit; and

FIG. 8B illustrates an exemplary collar and connecting elements with strain gauge installations having a memory and a processor coupled to a reader unit.

### DETAILED DESCRIPTION

Various embodiments and aspects of the invention will now be described in detail with reference to the accompanying figures. Still other aspects, features, and advantages of the present invention are readily apparent from the entire description thereof, including the figures, which illustrates a number of exemplary embodiments and implementations. The invention is also capable of other and different embodiments, and its several details can be modified in various respects, all without departing from the spirit and scope of the present invention. Accordingly, the drawings and descriptions are to be regarded as illustrative in nature, and not as restrictive. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited. Likewise, the term “comprising” is considered synonymous with the terms “including” or “containing” at least for purposes of Australian or the U.S.A. law.

In this disclosure, whenever a composition, an element or a group of elements' is preceded with the transitional phrase “comprising”, “including” or an equivalent thereof, it is understood that we also contemplate the same composition, element or group of elements with transitional phrases “consisting essentially of”, “consisting”, “selected from the group of consisting of”, or “is” preceding the recitation of the composition, element or group of elements and vice versa.

All numerical values in this disclosure are understood as being modified by “about”. All singular forms of elements, such as collars or connecting elements, or any other components described herein including (without limitations) components of the systems or methods of the invention are understood to include plural forms thereof and vice versa.

The present invention provides, systems, installations and methods that allow structural monitoring of pipes, such as a rigid, semi-rigid or flexible pipe, particularly of the types used in the subsea oil and gas industry. However, the exemplary systems, installations and methods can also be used in any suitable structure where structural monitoring is desirable. For example, the invention may also be used in extensometry in civil engineering, public works and geotechnical engineering, e.g., to monitor road or railway bridges or viaducts, dams for hydroelectric power stations, nuclear reactor buildings and cooling towers associated with these reactors, miscellaneous buildings, tunnels and mines, rock movements and ground movements, or to check land or submarine seismic areas, buried pipes, pipelines, riser pipes, which may be flexible riser pipes, dikes and offshore platforms.

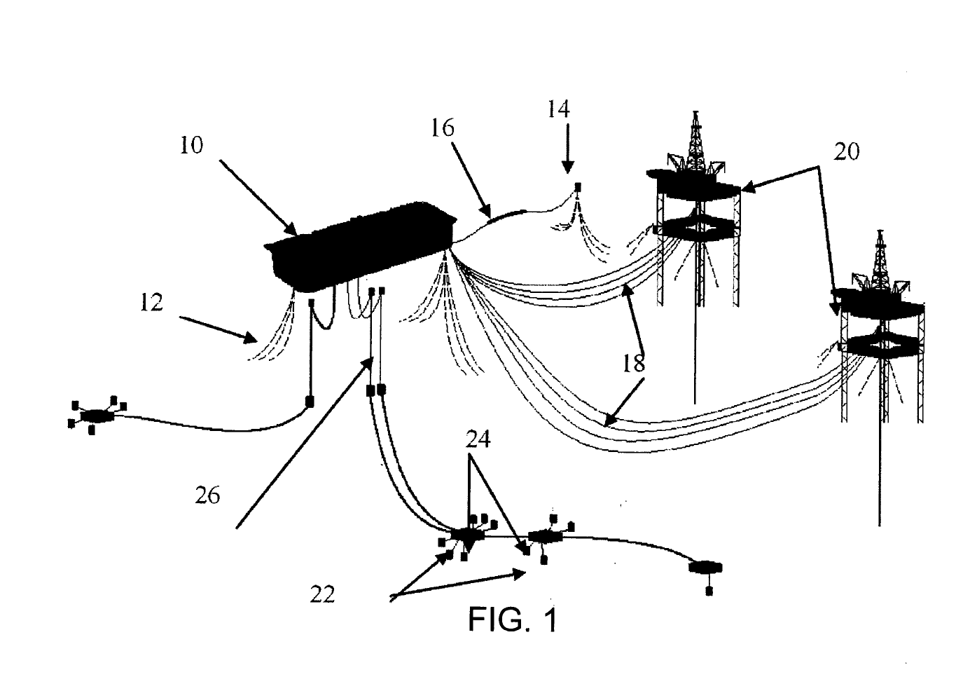

Referring now to the drawings, wherein like reference numerals designate identical or corresponding parts throughout the several views, and more particularly to FIG. 1 thereof, there is illustrated a subsea system, including a Floating Production Storage and Offloading (FPSO) vessel 10, which is anchored to the sea bed by anchor chains 12. A tanker offloading buoy 14 is connected to the FPSO 10 by means of a flexible offloading pipeline 16. Further flexible flowlines 18 connect the FPSO 10 to nearby platforms 20 to allow direct production to the FPSO. Also, existing subsea wells 22 have connections to subsea manifolds 24 from which flexible flowlines and risers 26 lead to connect to the FPSO 10. Advantageously, the methods and systems of the exemplary embodiments allow for monitoring of pipelines 16, flowlines 18 and risers 26 through which fluids flow, as well as structural pipes, such as those used in the support structures of the platform(s) 20. Accordingly, with the exemplary embodiments the monitoring of loads on flexible pipes, structures, and the like, is possible and useful for predicting or detecting damage and/or failure of such pipes and structures in subsea installations.

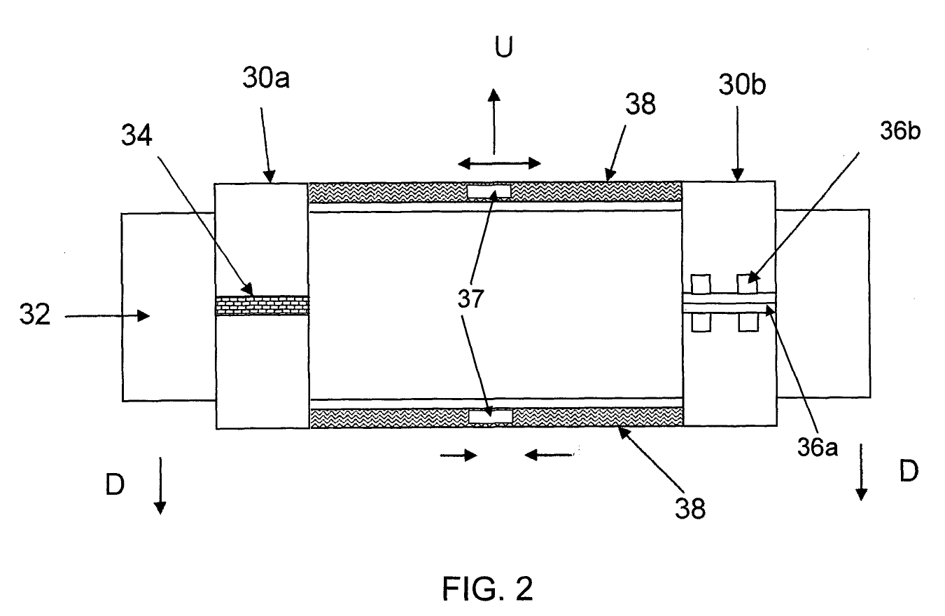

In an exemplary embodiment, a matrix of collars, and connecting elements each of which includes one or more strain gauges is provided and configured to detect distortion of the pipe to which it is attached. FIG. 2 illustrates an exemplary embodiment, including a pair of collars 30a and 30b clamped around a pipe 32. The collars 30a and 30b are formed from two semi-circular rings joined by means of a hinge 34 on one side (e.g., shown for collar 30a), a flange 36a and connectors 36b (e.g., nuts and bolts, shown for collar 30b). By unfastening the connectors 36b and the flange 36a, the collars 30a and 30b can be opened and placed around the pipe 32. The flange 36a and the connector 36b can then be closed and the connectors 36b tightened until the collars 30a and 30b are securely clamped around the pipe 32. Each of the collars 30a and 30b also includes end fittings for one or more connecting elements 38. For example, two connecting elements 38 are shown, disposed on opposite sides of the pipe 32, each of which carries a strain gauge 37 on or in its structure. In further exemplary embodiments, the number and arrangement of the connecting elements and collars can be selected according to operational requirements. An advantageous form of the strain gauge is a fiber optic sensor, such as a Bragg grating device, and the like.

By securing the collars 30a and 30b to the pipe 32, and fixing the ends of the connecting elements 38 to the collars 30a and 30b, the connecting elements 38 are effectively linked to the outer surface of the pipe 32. Therefore, any deformation of the pipe 32 in the region between the collars 30a and 30b will cause a corresponding deformation in the connecting elements 38, which can be detected by the attached strain gauge 37 and analyzed. For example, if the pipe 32 is bent in the plane of the drawing so that the ends move downwards (shown as arrows D in FIG. 2) and the middle upwards (shown as arrow U in FIG. 2), the upper connecting element 38 will be stretched and the lower connecting element 38 compressed. Different effects will also be found if the pipe is subjected to axial compression or extension, shear, or torque depending on the loads applied.

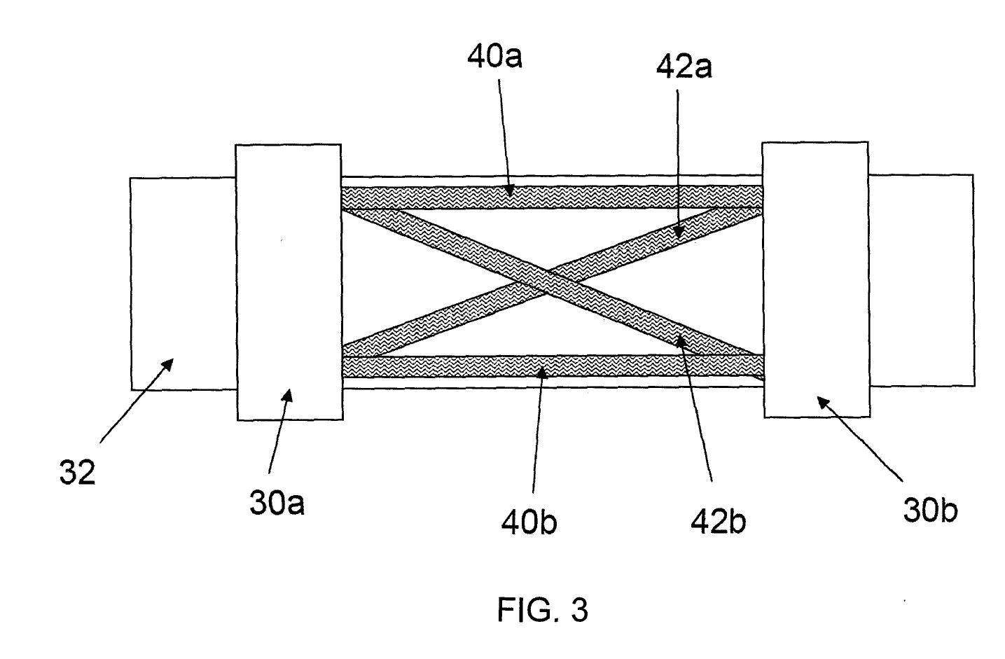

FIG. 3 illustrates a further exemplary embodiment in which several connecting elements having strain gauges (not shown) are provided. In FIG. 3, a pair of connecting elements 40a and 40b is aligned with the axis of the pipe 32, and another pair of connecting elements 42a and 42b has connection points on the collars 30a and 30b that are circumferentially offset, so that the connecting elements 42a and 42b lie at an angle to axis of the pipe 32. Advantageously, the number and arrangement of connecting elements can be selected according to the loads and deformations to be monitored.

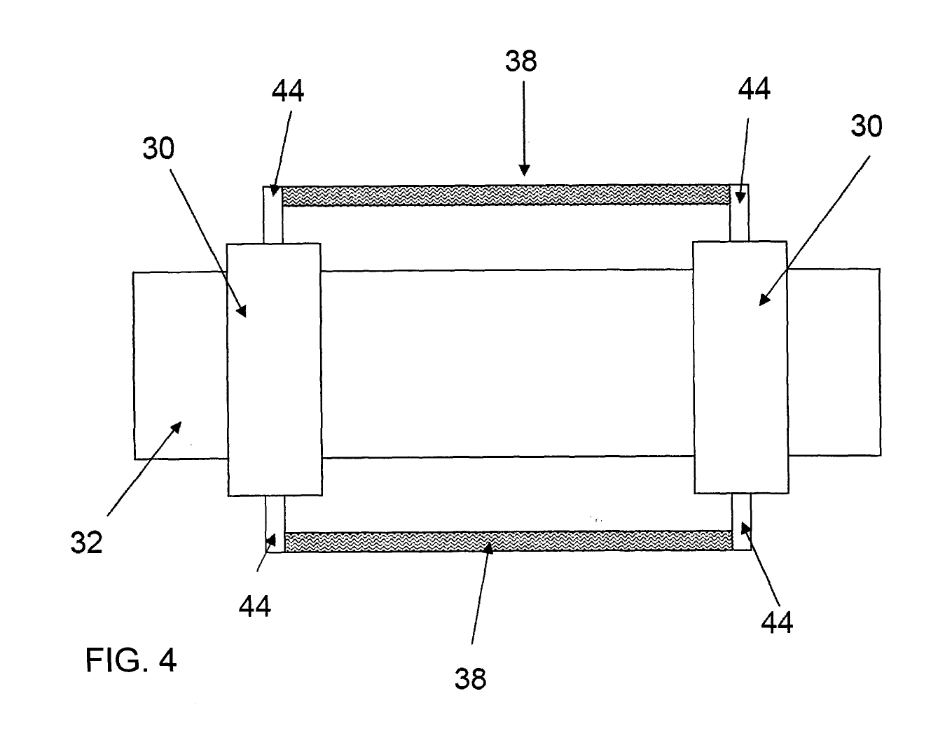

FIG. 4 illustrates a further exemplary embodiment in which the sensitivity to deformation is amplified. In FIG. 4, the connecting elements 38, which include strain gauges (not shown) are fixed to the collars 30 by means of radial extensions 44. The effect of the radial extensions 44 is to amplify mechanically any bending or shear deformation at the surface of the pipe 32. The greater the distance a given connecting element is offset from the surface of the pipe 32, the greater the amplification of the deformation. Radial offset is one way in which the response of the system can be tuned. Other ways to tune the system include the separation of the collars or varying thickness of the connecting elements.

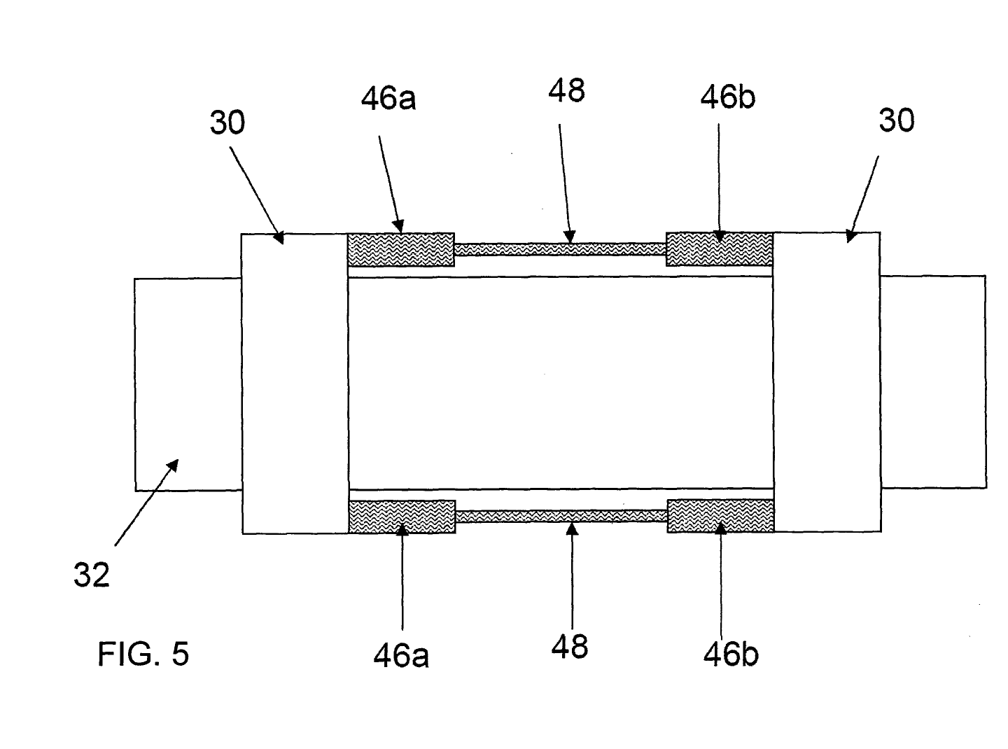

FIG. 5 illustrates a further exemplary embodiment in which the thickness of the connecting elements is varied. In FIG. 5, the connecting elements, having strain gauges (not shown), include thick end portions 46a and 46b connected to the collars 30 and center sections 48 that are of reduced diameter. The effect of the reduced diameter is that the connecting element is much more sensitive to deformation. Advantageously, this embodiment can be combined with the other embodiments discussed herein to obtain the desired sensitivity of the system. It is also possible to alter the stiffness of the connecting elements structure by modifying the mechanical parameters of the material used instead or in addition to the variation in shape. Composite materials could be used for this purpose, as their mechanical parameters can be designed to vary with length.

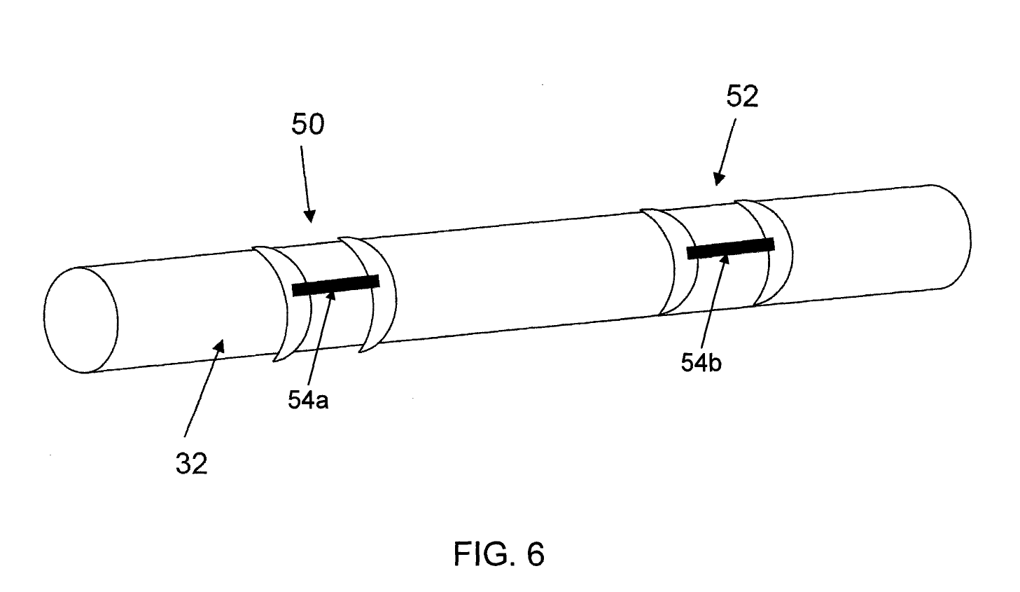

Because the system of the invention can be retroactively retrofitted onto a pipe, which is already placed in service or is ready to be placed in service, it can be fixed in any location where load deformation may be an issue. Furthermore, multiple installations can be provided on any given pipe, as is shown in FIG. 6. In FIG. 6, two sets of collars 50 and 52 and at least two connecting elements 54a and 54b having strain gauges (not shown) are provided on the pipe 32 in different locations. Advantageously, this approach can assist in cases where it is not possible to instrument directly a region of the pipe 32, wherein outputs from the offset installations can be used to interpolate or extrapolate parameters to the inaccessible regions. In addition, it is possible to monitor different parts of the pipe 32 having different load strengths and crossreference readings from other locations.

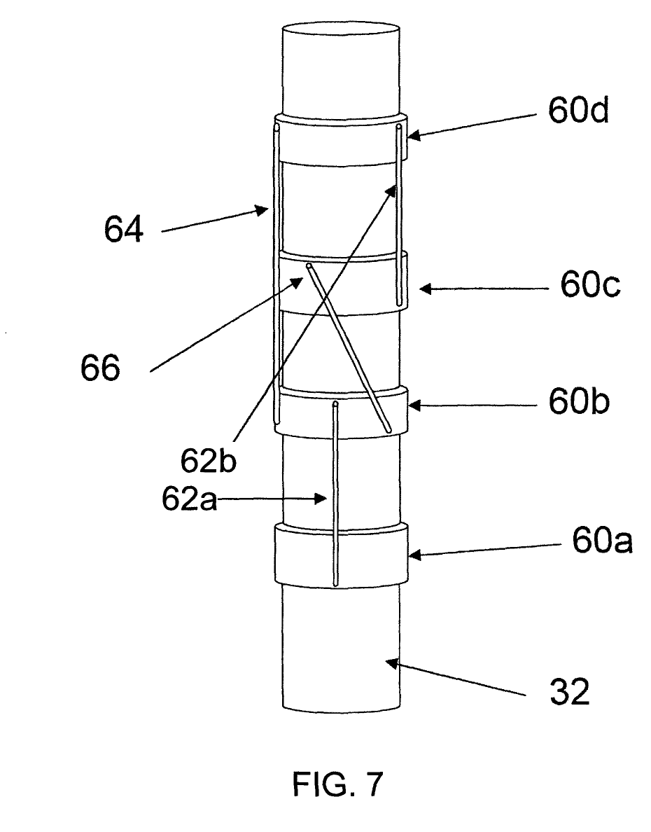

FIG. 7 shows an exemplary embodiment with multiple collars and connecting elements having strain gauges (not shown). It is possible to “daisy-chain” the system to measure different parameters at different positions and/or directions. In FIG. 7, four collars 60a-60d are mounted on the pipe 32. In some cases, simple connecting elements 62a and 62b, for example, as described in relation to FIG. 2, connect adjacent collars 60a and 60b, 60c and 60d, respectively. Other connecting elements, such as connecting element 64, can connect three collars 60b, 60c and 60d. Further a connecting element 66 can be arranged at an angle, for example, as shown in FIG. 3. The number of collars, and the number and arrangement of connecting elements can be selected according to the pipe and the type of load to be evaluated. Advantageously, it is possible to monitor different parts of the pipe 32 having different load strengths and cross-reference readings from other locations to obtain the desired sensitivity of the system.

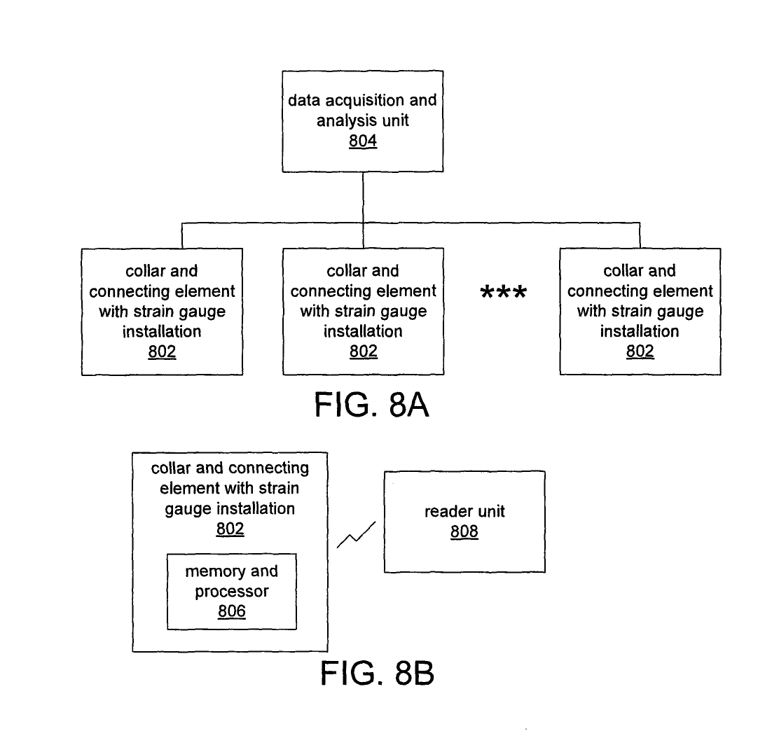

As shown in FIG. 8A, each collar and connecting element with strain gauge installation 802 of the exemplary embodiments of FIGS. 2-7 is effectively a stand-alone measurement sub-system and can feed back its readings to a data acquisition and analysis unit 804 (e.g., a personal computer, laptop computer, etc.) located at the surface or at any other suitable location, e.g., a remote location. In addition, as shown in FIG. 8B, a memory and processor 806 can be provided in each collar and connecting element with strain gauge installation 802, and which can accumulate data that in turn can be downloaded by a reader unit 808 that is brought into close proximity to the respective collar and connecting element with strain gauge installation 802.

The data acquisition and analysis unit 804 can be used to compare the data received from the strain gauges with a given threshold, thereby making it possible to detect an abnormal twist of the pipe 32 and the unit 804 can generate information or an alarm that allows the operator to anticipate the malfunction or breakage of the flexible pipe, and therefore to take an appropriate action.

While monitoring load deformation of flexible pipes is of particular interest, similar effects can also be monitored in rigid and semi-rigid pipes. However, in flexible pipe applications, the particular design and configuration of the monitoring installation can itself affect the flexibility of the pipe in that specific region. It is generally considered preferable that the installation provides the least possible resistance to the load structure. Where possible, it is preferable not to add significantly to the pipe stiffness, as this in turn may affect the sensitivity to the parameter being measured. One resulting advantage is that the clamping force of the collars and the friction force do not need to be very high to retain the collars in place on the pipe.

All or a portion of the devices and subsystems of the exemplary embodiments can be conveniently implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software. In addition, one or more general purpose computer systems, microprocessors, digital signal processors, microcontrollers, and the like, can be employed and programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art(s).

While the inventions have been described in connection with a number of exemplary embodiments, and implementations, the inventions are not so limited, but rather cover various modifications, and equivalent arrangements, which fall within the purview of the appended claims.

What is claimed is:

1. An apparatus for measuring loads on a pipe, the apparatus comprising
a pair of collars that are secured around an outer surface of a pipe to be monitored and in an axially spaced relationship;
a connecting element fixed to the collars such that when the collars are secured to the pipe, distortion of the pipe due to applied loads causes distortion of the connecting element, wherein the ends of the connecting element are attached to the collars such that when the collars are secured to the pipe, the ends of the connecting element are fixed against axial and circumferential movement relative to the pipe; and
at least one strain gauge fixed to or included in the connecting element so as to measure a distortion of the connecting element.

2. The apparatus of claim 1, wherein the at least one strain gauge is a fiber optic device.

3. The apparatus of claim 1, wherein the attachment points on the collars for the at least one strain gauge are aligned axially.

4. The apparatus of claim 1, wherein the attachment points on the collars are offset circumferentially so that the at least one strain gauge lies at an angle to the pipe axis.

5. The apparatus of claim 1, wherein the attachment points are offset radially from a surface of the pipe.

6. The apparatus of claim 1, wherein the diameter of the connecting element varies along its length.

7. The apparatus of claim 1, wherein the mechanical properties of the connecting element vary along its length.

8. The apparatus of claim 1, wherein the stiffness of the connecting element varies along its length.

9. The apparatus of claim 1, wherein the material of the connecting element is a polymer or a composite.

10. The apparatus of claim 1, wherein the mechanical proprieties and/or dimensions of the connecting element are varied with length in order to optimize the loading on the at least one strain gauge.

11. The apparatus of claim 1, wherein multiple connecting elements are fixed between the collars.

12. The apparatus of claim 1, wherein multiple collars and connecting elements are used.

13. The apparatus of claim 11, wherein the connecting elements are mounted so as to have different alignment between the collars.

14. An installation for measuring loads on a pipe, the installation comprising:
a pipe to be monitored; and
an apparatus for measuring loads on the pipe,
wherein the apparatus comprises:
a pair of collars that are secured around an outer surface of the pipe in an axially spaced relationship;
a connecting element fixed to the collars such that when the collars are secured to the pipe, distortion of the pipe due to applied loads causes distortion of the connecting element, wherein the ends of the connecting element are attached to the collars such that when the collars are secured to the pipe, the ends of the connecting element are fixed against axial and circumferential movement relative to the pipe; and
at least one strain gauge fixed to or included in the connecting element so as to measure a distortion of the connecting element.

15. The installation of claim 14, further comprising a data acquisition and analysis unit, and means for passing data to the analysis unit from the at least one strain gauge.

16. The installation of claim 15, wherein a plurality of the apparatus are provided, spaced apart along the pipe to be monitored.

17. The installation of claim 16, wherein the plurality of the apparatus is coupled to the data acquisition and analysis unit.

18. The installation of claim 14, wherein the pipe is rigid, semi-rigid or flexible.

19. The installation of claim 18, wherein the pipe forms part of a subsea oil or gas installation.

20. The installation of claim 19, wherein the pipe is a riser, a flow line, an umbilical or an offloading line.

21. The installation of claim 19, wherein the pipe is soft or covered with a soft material.

22. The installation of claim 19, wherein the soft material is thermal insulation.

23. A method of monitoring loads on a pipe, the method comprising:
providing a pair of collars having a connecting element fixed therebetween;
securing the collars around an outer surface of a pipe to be monitored in an axially spaced relationship, such that when the collars are secured to the pipe, the ends of the connecting element are fixed against axial and circumferential movement relative to the pipe;
providing at least one strain gauge fixed to or included in the connecting element; and
measuring distortion of the pipe due to applied loads.

24. The method of claim 23, wherein the method is performed using the apparatus of claim 1.

25. The method of claim 24, comprising providing multiple of the apparatus located at different locations on the pipe to be measured.

26. The method of claim 25, wherein the distortion of the pipe is used to indicate or evaluate a deterioration of a component of the pipe.

27. The method of claim 26, wherein the deterioration is a thinning or rupture of a component of the pipe.

28. The method of claim 27, wherein the component is a metal or composite strand in the pipe.
